(19) United States
(12) Patent Application Publication
(10) Pub. No.: US 2025/0131743 A1
(43) Pub. Date: Apr. 24, 2025

(54) IMAGE GENERATING SYSTEM

(71) Applicant: TOYOTA JIDOSHA KABUSHIKI KAISHA, Toyota-shi (JP)

(72) Inventor: Masahiro TANAKA, Tokyo-to (JP)

(73) Assignee: TOYOTA JIDOSHA KABUSHIKI KAISHA, Toyota-shi (JP)

(21) Appl. No.: 18/760,592

(22) Filed: Jul. 1, 2024

(30) Foreign Application Priority Data
Oct. 20, 2023 (JP) 2023-180832

(51) Int. Cl. G06V 20/56; G06V 10/25; G06V 10/44

(52) U.S. Cl. CPC G06V 20/588; G06V 10/25; G06V 10/44; G06V 2201/07

(57) ABSTRACT

An image generating system has a server having a server processor configured to generate area information for determining an area in which a road feature is included in an image based on feature information representing the road feature acquired in the past, and transmit the area information using a server-communication device and an image generating device having a device processor configured to receive the area information using a device-communication device, determine a cutout area to be cut out from an image captured using an image capturing device based on the area information, and cut out the cutout area from the image to generate a partial image, wherein the device processor transmits the partial image to the server using the device-communication device.

### FIELD

The present invention relates to an image generating system.

### BACKGROUND

It is necessary that a high-precision map which an automatic driving system of a vehicle refers to for automatic driving of the vehicle accurately represents the information on the road being driven on. In particular, the high-precision map represents road features around the road. Therefore, probe data representing the road features around the road is collected from the vehicle actually traveling in the predetermined area (e.g., see Japanese Unexamined Patent Publication No. 2020-187432).

The vehicle generates probe data while traveling on the road and transmits probe data to the server. The server receives probe data from the vehicle and generates or updates a high-precision map based on probe data.

The server compares the information of road features collected from the vehicle with the current map information of the high-precision map. The server newly requests the vehicle to transmit video (a plurality of images) in which a detected road feature is included in order to update the map information when there is a change in the current map information by comparison with the road feature.

### SUMMARY

However, when the video is transmitted from the vehicle to the server, since the video includes a large amount of information compared to the information of the road feature (e.g., type and location), it is required to reduce the communication traffic volume.

It is an object of the present disclosure to provide an image generating system that can reduce the communication traffic volume when transmitting an image including a road feature.

(1) According to one embodiment, an image generating system is provided. This image generating system has a server having a server processor configured to generate area information for determining an area in which a road feature is included in an image based on feature information representing the road feature acquired in the past, and transmit the area information using a server-communication device, and an image generating device having a device processor configured to receive the area information using a device-communication device, determine a cutout area to be cut out from an image captured using an image capturing device based on the area information, and cut out the cutout area from the image to generate a partial image, wherein the device processor transmits the partial image to the server using the device-communication device.

(2) In the image generating system of embodiment (1) above, it is preferable that the server processor is further configured to generate the area information to include a type of the road feature for which change has been detected based on the feature information, and the device processor is further configured to determine an area in the image according to the type of the road feature as the cutout area.

(3) In the image generating system of embodiment (1) above, it is preferable that the server processor is further configured to generate the area information to include location information of the road feature for which change has been detected based on the feature information, and the device processor is further configured to determine an area for which the road feature is estimated to be represented in an image acquired using the image capturing device as the cutout area based on the location information of the road feature.

(4) In the image generating system of embodiment (1) above, it is preferable that the server processor is further configured to generate change information representing a type of change in the road feature based on the feature information and to transmit the change information to the image generating device using the server-communication device, and the device processor is further configured to receive the change information using the device-communication device and determine the cutout area in an image acquired using the image capturing device based on the change information and the area information.

(5) In the image generating system of embodiment (4) above, it is preferable that the server processor is further configured to generate location information representing a location of the road feature for which change has been detected based on the feature information and to transmit the location information to the image generating device using the server-communication device and the device processor is further configured to receive the location information and the change information using the device-communication device, and to determine a section in which an image is to be captured using the image capturing device to generate the partial image based on the location information and the change information.

The image generating system according to the present disclosure is capable of reducing the communication traffic volume when transmitting an image including a road feature.

The object and advantages of the invention will be realized and attained by means of the elements and combinations particularly specified in the claims. It is to be understood that both the foregoing general description and the following detailed description are exemplary and are not restrictive of the invention, as claimed.

### BRIEF DESCRIPTION OF DRAWINGS

FIG. 1 is a schematic configuration diagram of a data collecting system of the present embodiment.

FIG. 2 is a sequence diagram of image generating processing of the data collecting system of the present embodiment.

FIG. 3 is a schematic configuration diagram of a vehicle in which the data collecting device is mounted.

FIG. 4 is an example of an operation flowchart of section determination processing of the data collecting device.

FIG. 5 is an example of an operation flowchart of image generating processing of the data collecting device.

FIG. 6 is another example of an operation flowchart of image generating processing of the data collecting device.

### DESCRIPTION OF EMBODIMENTS

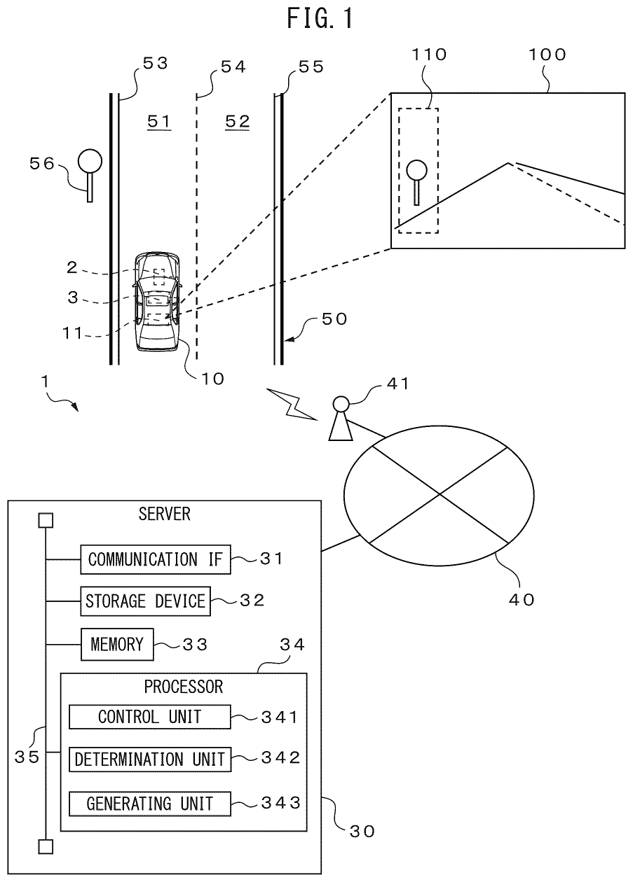

FIG. 1 is a schematic configuration diagram of a data collection system 1 in which the data collecting device 11 of the present embodiment is implemented. The data collecting system 1 includes at least one vehicle 10 and a server 30. The data collecting device 11 is implemented in the vehicle 10. For example, the vehicle 10 is connected to the server 30 through the macrocell base station 41 and the communication network 40, by accessing the wireless base station 41 (hereinafter also referred to as macrocell base station 41) that provides a macrocell connected to the communication network 40 to which the server 30 is connected via a gateway (not shown) or the like. The data collecting system 1 is an example of an image generating system. The data collecting device 11 is an example of an image generating device.

In FIG. 1, although only one vehicle 10 is shown, the data collection system 1 may have a plurality of vehicles. Similarly, a plurality of macrocell base stations 41 may be connected to the communication network 40.

The vehicle 10 is traveling on a road 50. The road 50 has two lanes 51, 52. The vehicle 10 is traveling in the lane 51. The lane 51 is partitioned by a lane marking line 53 and lane marking line 54. The lane 52 is partitioned by a lane marking line 54 and lane marking line 55.

The server 30 acquires probe data or the like representing the road features from the data collecting device 11 and generates or updates a high-precision map. The high-precision map is referred to for the automatic driving vehicle to operate the vehicle automatically.

The server 30 detects changes in the road features by comparing information representing the acquired road features with current high-precision map. The change in the road feature includes installation of a new road feature, change in location of the road feature, and removal of the road feature.

The server 30 requests the vehicle 10 to collect a video (a plurality of images) representing the road feature when a change in the road feature has been detected. The data collecting device 11 uses the camera 2 to capture a camera image 100 representing the road feature for which the change has been detected. The data collecting device 11 generates a partial image 110 in which the area representing the road feature is cut out from the camera image 100. The data collecting device 11 transmits the partial image 110 to the server 30. The server 30 carries out updating of the high-precision map base on a plurality of images (video) representing the road feature for which the change has been detected.

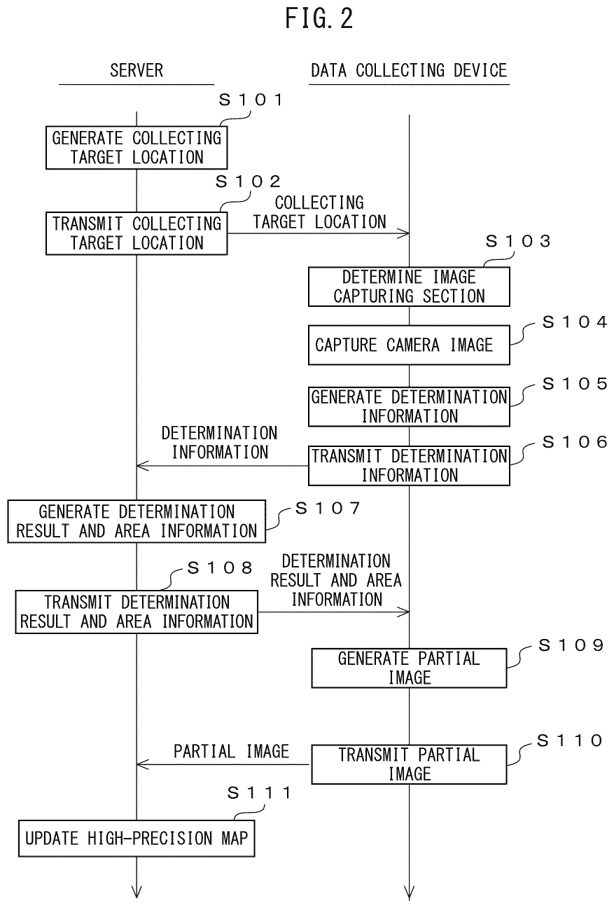

FIG. 2 is a sequence diagram of image generating processing of the data collecting system 1. Referring to FIG. 2, an overview of the operation of the data collecting system 1 will be described below. In FIG. 1, although only one vehicle 10 is illustrated, the server 30 can perform the same processing for a plurality of vehicles.

First, the server 30 generate a collecting target location representing the location of the road feature where the change has been detected based on the feature information representing the road feature acquired in the past (step S101). The collecting target location represents the location where the image is to be captured. The collecting target location is an example of the location information representing the position of the road feature where the change has been detected.

The collecting target location is expressed in such a way that the location can be determined by positioning information such as GNSS information. The collecting target location may be associated with a road section in which the road feature for which the change has been detected is located. The collecting target location is represented, for example, in world coordinates. In the example shown in FIG. 1, the collecting target location represents the location of the road feature 56 for which the change has been detected.

The server 30 may also generate change information representing a type of change of the road feature. For example, the type of change includes the change of the location of the road feature, installation of a new road feature and removal of the road feature. The change information may not be generated.

The server 30 then transmit the collecting target location and change data to the vehicle 10 through the communication network 40 and the macrocell base station 41 (step S102).

The data collecting device 11 receives the collecting target location and change information. When no change information is generated, only the collecting target location is received.

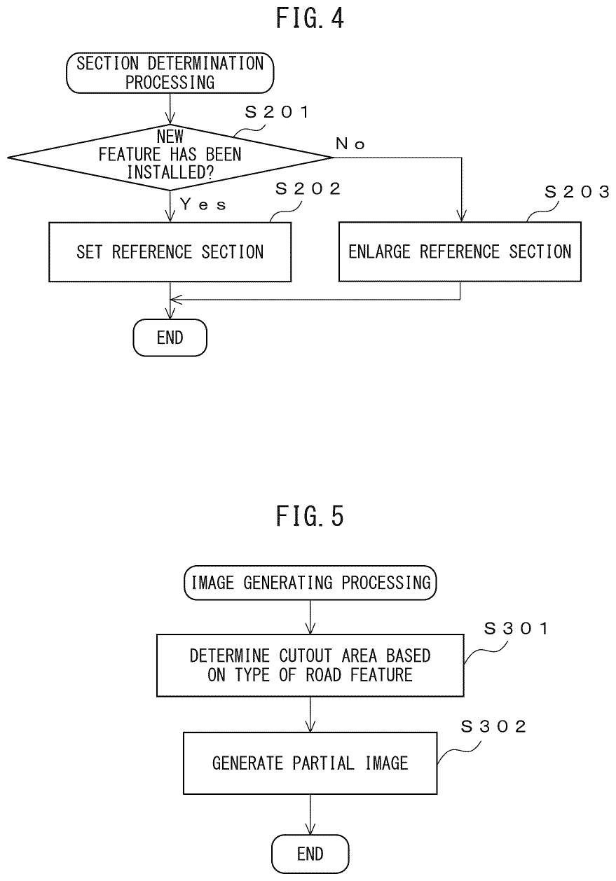

The data collecting device 11 determines the image capturing section where the camera images are to be captured using the camera 2 in order to generate partial images based on the collecting target location and change information (step S103). In the case where the change information is not generated, the image capturing section is determined based on the collecting target location. The section determination processing in which the image capturing section is determined by the data collecting device 11 will be described later with reference to FIG. 4.

When the vehicle 10 enters the image capturing section, the data collecting device 11 begins capturing camera images representing the environment around the vehicle 10 using the camera 2 (step S104).

Further, the data collecting device 11 begins generating the determination information (step S105). The determination information includes, for example, the location of the vehicle 10 and the acquisition state of the camera image. The acquisition state of the camera image indicates whether the camera image is successfully captured or not. The data collecting device 11 generates the determination information for each predetermined image acquisition period. For example, the data collecting device 11 generates the determination information every predetermined period (e.g., 10 seconds to several minutes), or each time the vehicle 10 travels a predetermined distance (e.g., 100 m to 1 km). During the image acquisition period, the camera image is acquired in a predetermined period.

Next, the data collecting device 11 transmits the determination information to the server 30 through the macrocell base station 41 and the communication network 40 using the communication device 3 (step S106). The server 30 receives the determination information.

The server 30 generates a determination result and area information based on the determination information (step S107). For example, when the location of the vehicle 10 corresponds to the collecting target location and the camera image is normally captured, the server 30 generates a determination result for requesting transmission of the image. On the other hand, when the location of the vehicle 10 does not correspond to the collecting target location or the camera image is not captured normally, the server 30 generates a determination result for not requesting transmission of the image.

In addition, when generating the determination result for requesting transmission of the image, the server 30 generates an area information for determining the area in which the road feature is included in the image. The area information is used at the data collecting device 11 to determine the area in the camera image where the road feature is included. The area information includes, for example, a type of the road feature or location information representing the location of the road feature.

The server 30 transmits the determination result and area information to the data collecting device 11 through the communication network 40 and the macrocell base station 41 (step S108). The data collecting device 11 receives the determination result and area information.

When receiving the determination result for requesting transmission of the image, the data collecting device 11, based on the area information, determines a cutout area to be cut out from the camera image captured using the camera 2, and cut out the camera image to generate a partial image (step S109).

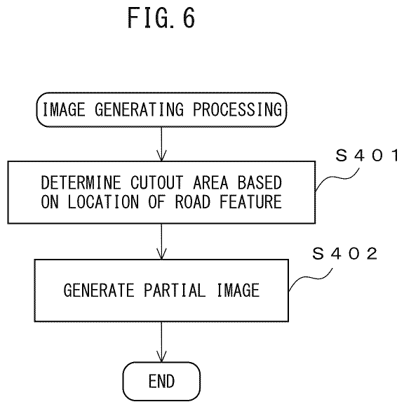

In the example shown in FIG. 1, the data collecting device 11 generates a partial image 110 from a camera image 100. The partial image 110 has less volume of the information than the camera image 100. For example, the volume of the information of the partial image 110 will be less than half that of the camera image 100. The image generation processing in which the partial image is generated by the data collecting device 11 will be described later with reference to FIGS. 5 and 6.

Next, the data collecting device 11 transmits the partial images to the server 30 through the macrocell base station 41 and communication network 40 using the communication device 3 (step S110). The data collecting device 11 generates the partial images from each of the camera images captured during the image acquisition period and transmits the partial images to the server 30. The server 30 receives the plurality of partial images.

Next, the server 30 update the high-precision map based on the plurality of partial images (step S111), and the series of processing steps is complete.

Incidentally, when receiving the determination result not requesting transmission of the image, the data collecting device 11 does not generate a partial image for the camera image captured in the image acquisition period in which the determination information is generated. The data collecting device 11 carries out the above-described processing steps S104 to S110 while the vehicle 10 is traveling in the image capturing section.

According to the data collection system 1 of the present embodiment described above, the partial image including the area determined to include the road feature in the camera image captured by the vehicle 10 at the position where the change of the road feature has been detected is transmitted to the server 30. This allows the data collecting system 1 to reduce the communication traffic volume when transmitting an image including the road feature.

Although a plurality of vehicles may be included in the data collecting system 1, the following will be described for one vehicle 10, since each vehicle may have the same configuration and carries out the same processing with respect to the data collecting processing.

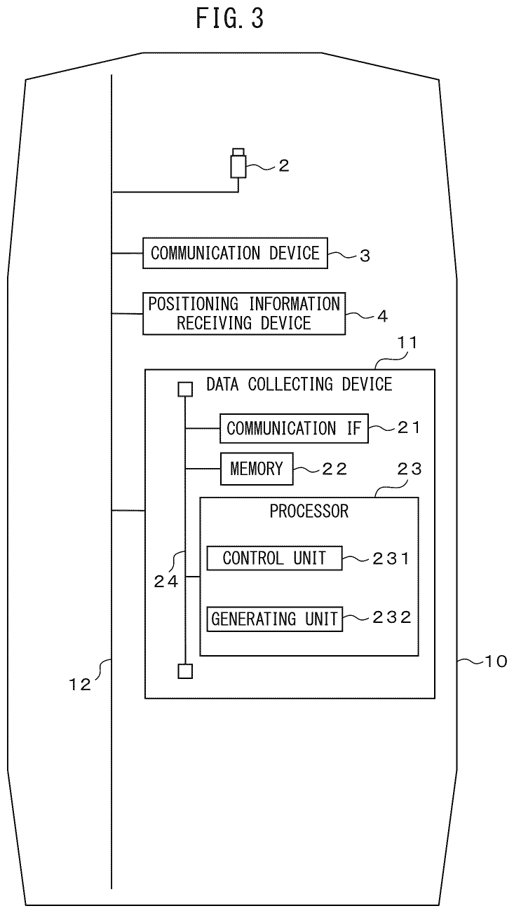

Next, the vehicle 10 on which the data collecting device 11 is mounted will be described below with reference to FIG. 3. FIG. 3 is a schematic configuration diagram of the vehicle 10 in which the data collecting device 11 is mounted.

The vehicle 10 includes a camera 2, a communication device 3, a positioning information receiving device 4, a data collecting device 11, and the like. The vehicle 10 may further include a ranging sensor (not shown) for measuring the distance of objects surrounding the vehicle 10, such as LiDAR sensor.

The camera 2, the communication device 3, the positioning information receiving device 4, and the data collecting device 11 are communicably connected through an in-vehicle network 12 conforming to a standard such as a controller area network.

The camera 2 is mounted to the vehicle 10 so as to face the front of the vehicle 10. The camera 2 captures a camera image in which an environment of a predetermined area in front of the vehicle 10 is represented, for example, at a predetermined cycle. The camera image is an example of information representing the environment around the vehicle 10. The camera image may represent a road included in a predetermined area and road features around the road in front of the vehicle 10. The camera 2 is an example of an image capturing device.

The camera 2 has a 2D detector composed of an array of photoelectric conversion elements with visible light sensitivity, such as a CCD or C-MOS, and an imaging optical system that forms an image of the captured region on the 2D detector.

The camera 2 outputs the camera image and the camera image captured time at which the camera image is captured to the data collecting device 11 through the in-vehicle network 12 each time the camera image is acquired.

The communication device 3 has interface circuitry for connecting the data collecting device 11 to the macrocell base station 41. The communication device 3 is configured to communicate with the server 30 through the macrocell base station 41 and the communication network 40. The communication device 3 is an example of a device-communication device.

The positioning information receiving device 4 outputs the positioning information representing the current location of the vehicle 10. For example, the positioning information receiving device 4 may be a GNSS receiver. Every time the positioning information receiving device 4 acquires GNSS information at a predetermined reception period, the positioning information receiving device 4 outputs the positioning information and the positioning information acquisition time at which the GNSS information is acquired to the data collecting device 11 or the like. The positioning information includes, for example, the current location of the vehicle 10 represented by the world coordinates. The current location of the vehicle 10 includes, for example, latitude and longitude.

The data collecting device 11 carries out control processing and generating processing. To this end, the data collecting device 11 includes a communication interface (IF) 21, a memory 22, and a processor 23. The communication interface 21, the memory 22, and the processor 23 are connected via signal wires 24. The communication interface 21 includes interface circuitry for connecting the data collecting system 11 to the in-vehicle network 12.

The memory 22 is an example of a storage unit, and for example, the memory 22 has a volatile semiconductor memory and a non-volatile semiconductor memory. The memory 22 may further include other storage devices, such as a hard disk drive. The memory 22 stores application computer programs and various data to be used for information processing carried out by the processor 23.

All or some of the functions of the data collecting device 11 are, for example, functional modules implemented by a computer program running on the processor 23. The processor 23 includes a control unit 231 and a generating unit 232. Alternatively, the functional module of the processor 23 may be a dedicated arithmetic circuit provided in the processor 23. The processor 23 includes one or more CPUs (Central Processing Units) and their peripheral circuitry The processor 23 may further include other arithmetic circuitry, such as a logic unit, a numerical unit, or a graphic processing unit. The data collecting device 11 is, for example, an electronic control unit (ECU).

The control unit 231 carries out processing for capturing a camera image, processing for generating determination information, processing for transmitting determination information, and processing for transmitting a partial image. The generating unit 232 carries out processing for determining an image capturing section and processing for generating a partial image. The processing for determining the image capturing section and processing for generating the partial image by the generating unit 232 will be described later. The control unit 231 is an example of a device-communication control unit. The generating unit 232 is an example of an image generating unit.

FIG. 1 shows a hardware configuration diagram of the server 30. The server 30 carries out control processing, determination processing, and generating processing. To this end, the server 30 includes a communication interface (IF) 31, storage device 32, memory 33, and processor 34. The communication IF 31, the storage device 32 and the memory 33 are connected to the processor 34 via signal wires 35. The server 30 may further include an input device such as a keyboard and a mouse, and a display device such as a liquid crystal display.

The communication IF 31 has interface circuitry for connecting the server 30 to the communication network 40. The communication IF 31 is configured to communicate with the vehicle 10 through the communication network 40 and the macrocell base station 41. The communication IF 31 is an exemplary server-communication unit.

The storage device 32 includes, for example, a hard disk device or an optical storage medium and its access device. The storage device 32 stores probe data and images transmitted from the vehicle 10, the high-precision map, the collecting target location, and the like. The storage device 32 may also store computer programs for performing the processing associated with the data collecting of the server 30 and the processing for generating and updating the high-precision map executed on processor 34. The storage device 32 is an example of a storage unit.

The memory 33 includes, for example, a volatile semiconductor memory and a non-volatile semiconductor memory. The memory 33 stores computer programs and various types of data for applications used in information processing carried out by the processor 34.

All or some of the functions of the server 30 are functional modules implemented, for example, by a computer program running on the processor 34. The processor 34 includes a control unit 341, a determination unit 342, and a generating unit 343. Alternatively, the functional modules of the processor 34 may be dedicated arithmetic circuits provided in the processor 34. The processor 34 includes one or more CPUs (Central Processing Units) and its peripheral circuitry. The processor 34 may further include other arithmetic circuitry, such as a logic unit, a numerical unit, or a graphic processing unit. The control unit 341 is an example of a server-communication control unit. The generating 343 is an example of an area information generating unit. In addition, the generating unit 343 is an example of a change information generating unit. Further, the generating unit 343 is an example of a location information generating unit.

The control unit 341 carries out the transmission processing of the collecting target location, and the transmission processing of the determination result and area information. In the transmission processing of the collection target location, the control unit 341 transmits the collecting target location to the data collecting device 11 at the location notification time having a predetermined period, using the communication IF 31.

The determination unit 342 carries out the generation processing of the determination result based on the determination information. The determination unit 342 generates a determination result for requesting transmission of the image when the location of the vehicle 10 corresponds to the collecting target location and the camera image is normally captured. On the other hand, the determination unit 342 generates a determination result for not requesting transmission of the image when the location of the vehicle 10 doesn't correspond to the collecting target location or the camera image is not captured normally. The determination processing may be carried out based on other information included in the determination information.

The determination unit 342 obtains the location and the traveling direction of the vehicle 10 in the image acquisition period based on the location of the vehicle 10 included in the determination information. Then, the determination unit 342 identifies the road section where the vehicle 10 is located based on the location and the traveling direction of the vehicle 10 when the camera image is captured. When the identified road section coincides with the road section associated with the collecting target location, the determination unit 342 may determine that the location of the vehicle 10 corresponds to the collecting target location.

The generating unit 343 generates the collecting target location representing the location of the road feature where the change has been detected, based on the feature information representing the road feature acquired in the past. The feature information representing a road feature acquired in the past includes, for example, a location or type of the road feature represented in probe data. The collecting target location is represented by, for example, a two-dimensional location or a three-dimensional location of the world coordinate system. The generating unit 343 associates the road section in which the road feature for which the change has been detected with the collecting target location.

For example, when information representing a predetermined number of road features is collected, the server 30 determines whether or not a change in the road feature has been detected in comparison with the current high-precision map.

The generating unit 343 may generate change information representing the type of change of the road feature based on the feature information representing the road feature acquired in the past. When the dispersion of the location of the road feature exceeds the reference dispersion value, the generating unit 343 determines that the location of the road feature has changed. In addition, when a number of detecting a new road feature becomes equal to or more than a predetermined first reference value, the generating unit 343 determines that the new road feature has been installed. Furthermore, when the detection ratio of the road feature is equal to or less than a predetermined second reference value, the generating unit 343 determines that the road feature has been removed. The generating unit 343 generates change information representing a type of change of the road feature. The type of change includes the change of the location of the road feature, installation of a new road feature and removal of the road feature.

The generating unit 343 carries out the area information generation processing. The generating unit 343 generates area information for determining an area in which the road feature is included in the camera image based on the feature information representing the road feature acquired in the past. The area information is used to determine the area in the camera image where the road feature is included in the data collecting device 11.

For example, the generating unit 343 generates the area information to include the type of the road feature for which the change has been detected based on the feature information representing the road feature acquired in the past. The area information represents the type of the road feature for which the change has been detected. The type of the road feature includes road sign or display on the road surface (road sign on the road surface), and the like.

The generating unit 343 may also generate the area information to include the location information of the road feature for which the change has been detected, based on the feature information representing the road feature acquired in the past. The area information has location information representing the location of the road feature for which the change has been detected. The location information can be a three-dimensional location that represents the location of the road feature. The location information may be a two-dimensional location representing a location of a road feature and a type of a road feature. The location of a road feature, for example, is represented in the world coordinates.

In addition, the generating unit 343 generates a high-precision map using collected probe data and images. In addition, the generating unit 343 updates the high-precision map using collected probe data. For example, the generating unit 343 compares the newly collected road feature with the past collected road feature for the lane section to be updated to detect a road feature for which the change has been detected.

Based on the plurality of images transmitted from the data collecting device 11, it is determined whether the location of the road feature has been changed, a new road feature has been installed, or the road feature has been removed. The generating unit 343 updates information in the high-precision map based on the determination result. The high-precision map is stored in the storage device 32. The control unit 341 distributes the high-precision map to the automatic driving vehicles through the communication IF 31.

FIG. 4 is an example of an operation flowchart of section determination processing of the data collecting device 11. The section determination processing by the data collecting device 11 will be described below with reference to FIG. 4. The data collecting device 11 carries out the section determination processing shown in FIG. 4 each time it receives the collecting target location and change information.

First, the generating unit 232 of the data collecting device 11 determines whether or not the type of change included in the change information means that a new road feature has been installed (step S201).

When the type of change means that a new feature has been installed (step S201—Yes), the generating unit 232 sets a reference section as an image capturing section (step S202), and the series of processing steps is complete. The reference section means a predetermined range before and after the collecting target location. For example, the reference section means the range of a few 100 meters before and after the collecting target location. When a new road feature has been installed, the reference section is set as the image capturing section because the location of the road feature is definitive. The reference section may be a road section associated with the road feature.

On the other hand, when the type of change doesn't mean that a new road-feature has been installed (step S201—No), the generating unit 232 sets a section in which the reference section is enlarged as the image capturing section (step S202), and the series of processing steps is complete. When the type of change doesn't mean that a new road feature has been installed, the type of change includes that the location of the road feature has been changed or the road feature has been removed.

Since the location of the road feature is not definitive when the location of the road feature has been changed or the road feature has been removed, the image capturing section is enlarged more than the reference section. For example, the image capturing section is enlarged from 1.5 to 2.0 times larger than the reference section. The above is a description of the section determination processing.

FIG. 5 is an example of an operation flowchart of image generating processing of the data collecting device 11. The image generating processing by the data collecting device 11 will be described below with reference to FIG. 5. The data collecting device 11 carries out the image generating processing shown in FIG. 5 every time it receives the determination result for requesting transmission of an image and the area information representing the type of the road feature for which the change has been detected.

First, the generating unit 232 determines an area in the camera image according to the type of the road feature as a cutout area to be cut out from the camera image (step S301). For the camera images captured in the same image acquisition period, the same cutout area is set. When the type of the road feature is a road sign, the generating unit 232 determines a vertically long cutout area at the portion of the right or left edge of the camera image as shown in FIG. 1 since the road sign is located at the edge of the road. When the vehicle travels on the left side traffic, the cutout area is determined on the left side of the camera image. On the other hand, when the vehicle travels on the right side traffic, the cutout area is determined on the right side of the camera image. The location and size of the cutout area may be determined by default. The size of the cutout area is preferably equal to or less than half of the camera image.

In addition, when the type of the road feature is a road sign on the road surface, the generating unit 232 determines a horizontally long cutout area to include the central of the camera image since the road sign is displayed on the road surface. The location and size of the cutout area may be determined by default.

Here, the generating unit 232 may determine the cutout area based on the area information and change information. When the change information includes a change in the location of a road feature or a removal of a road feature, the cutout area may be enlarged from the default size. The reason for this is that the location of the road feature is not definitive when the location of the road feature has been changed or the road feature has been removed. On the other hand, when the change information means that a new road feature has been installed, the cutout area will be the default size. The reason for this is that the location of the road feature is definitive when a new road feature has been installed.

In addition, when the type of the road feature includes the road sign or the road sign on the road surface, the generating unit 232 may determine a vertical cutout area or horizontal cutout area for the camera image.

Next, the generating unit 232 cuts out the cutout area from the camera image to generate a partial image (step S302), and the series of processing steps is complete.

Since the partial image is a part of the original camera image, the volume of the information of the image can be reduced. Further, since the same cutout area is set for the camera images captured in the same image acquisition period, the plurality of partial images forms a moving image including the location of the road feature where the change has been detected. By this, the change of the road feature becomes clearly detectable by watching the moving image. The above is an example of the image generation processing.

FIG. 6 is another example of an operation flowchart of image generating processing of the data collecting device 11. The image generating processing by the data collecting device 11 will be described below with reference to FIG. 4. The data collecting device 11 carries out the image generating processing shown in FIG. 6 every time it receives the determination result for requesting transmission of the image and the area information including the location information representing the location of the road feature where the change has been detected.

First, the generating unit 232 determines an area where the road feature is estimated to be represented in the camera image as a cutout area based on the location information of the road feature (step S401).

When the area information includes the three-dimensional location representing the location of the road feature, the generating unit 232 estimates the position of the road feature represented in the camera image based on the three-dimensional location of the road feature, the location of the vehicle 10 and the traveling direction of the vehicle 10 at the time of image acquisition, and parameters such as the capturing direction of the camera 2, the focal length and the installation position. The generating unit 232 determines the cutout area so as to include the position of the road feature represented in the camera image. The size of the cutout area is set by default, for example. The size of the cutout area is preferably equal to or less than half of the camera image.

In addition, when the area information includes the two-dimensional location representing the location of the road feature and the type of the road feature, the generating unit 232 estimates the height of the road feature based on the type of the road feature to obtain the three-dimensional location representing the location of the road feature. As described above, the generating unit 232 determines the cutout area so as to include the position of the road feature represented in the camera image.

The generating unit 232 may divide the camera image into M in the vertical direction (M is a positive integer) and N in the horizontal direction (N is a positive integer). The generating unit 232 may select one or more areas of the divided areas to include the position of the road feature represented in the camera image to determine the cutout area.

In addition, the generating unit 232 may determine the cutout area based on the area information and change information. When the change information includes a change in the location of a road feature or the removal of a road feature, the cutout area may be enlarged from the default size. On the other hand, when the change information means an installation of a new road feature, the cutout area will be the default size.

Next, the generating unit 232 cuts out the cutout area from the camera image to generate a partial image (step S402), and the series of processing steps is complete. The above is a description of another example of the image generating processing.

According to the data collecting system of the present embodiment described above, it is capable of transmitting a partial image including an area determined to include a road feature in the camera image captured by a vehicle at a location in which a change of a road feature has been detected to a server. This allows the data collecting system to reduce the communication traffic volume when transmitting an image containing the road feature.

In the present disclosure, the data collecting system of the above-described embodiment can be appropriately changed without departing from the spirit of the present invention. Further, the technical scope of the present disclosure is not limited to those embodiments, but extends to the invention described in the claims and its equivalents.

For example, in the above-described embodiment, the image capturing section was determined based on the collecting target location and change information. On the other hand, when the change information is not generated, the image capturing section is determined based on the collecting target location. For example, the image capturing section may be the reference section.

In the embodiment described above, the area information has been transmitted to the data collecting device together with the determination result, the area information may be transmitted to the data collecting device together with the collecting target location. When the determination result for requesting transmission of an image is received, the data collecting device generates a partial image based on the prior received area information.

1. An image generating system comprising:
a server comprising:
a server processor configured to generate area information for determining an area in which a road feature is included in an image based on feature information representing the road feature acquired in the past, and transmit the area information using a server-communication device; and
an image generating device comprising:
a device processor configured to receive the area information using a device-communication device, determine a cutout area to be cut out from an image captured using an image capturing device based on the area information, and cut out the cutout area from the image to generate a partial image,
wherein the device processor transmits the partial image to the server using the device-communication device.

2. The image generating system according to claim 1, wherein
the server processor is further configured to generate the area information to include a type of the road feature for which change has been detected based on the feature information,
and the device processor is further configured to determine an area in the image according to the type of the road feature as the cutout area.

3. The image generating system according to claim 1, wherein
the server processor is further configured to generate the area information to include location information of the road feature for which change has been detected based on the feature information, and
the device processor is further configured to determine an area for which the road feature is estimated to be represented in an image acquired using the image capturing device as the cutout area based on the location information of the road feature.

4. The image generating system according to claim 1, wherein
the server processor is further configured to generate change information representing a type of change in the road feature based on the feature information and to transmit the change information to the image generating device using the server-communication device, and
the device processor is further configured to receive the change information using the device-communication device and determine the cutout area in an image acquired using the image capturing device based on the change information and the area information.

5. The image generating system according to claim 4, wherein the server processor is further configured to generate location information representing a location of the road feature for which change has been detected based on the feature information and to transmit the location information to the image generating device using the server-communication device and
the device processor is further configured to receive the location information and the change information using the device-communication device, and to determine a section in which an image is to be captured using the image capturing device to generate the partial image based on the location information and the change information.
